(19) United States
(12) Patent Application Publication
(10) Pub. No.: US 2012/0124777 A1
(43) Pub. Date: May 24, 2012

(54) HINGE CONNECTION FOR A TRANSPORT CONTAINER MADE OF PLASTIC

(75) Inventor: André Keller, Unterlunkhofen (CH)

(73) Assignee: GEORG UTZ HOLDING AG, Bremgarten (CH)

(21) Appl. No.: 13/320,319

(22) PCT Filed: May 4, 2010
(86) PCT No.: PCT/IB10/51957

§ 371 Date: Feb. 1, 2012

(30) Foreign Application Priority Data
May 13, 2009 (CH) 00752/09

(51) Int. Cl. E05D 5/12; E05D 5/14

(52) U.S. Cl. 16/381

(57) ABSTRACT

The invention relates to a novel hinge connection (1) for a transport container made of plastic, which hinge connection comprises a hinge part (2) designed as a sleeve (4) having a longitudinal opening (5) and a hinge clip (3) that encompasses the sleeve. The sleeve has a wide outer circumferential groove (6) for receiving the hinge clip, which has a recess (7) at least at one of the ends thereof. The hinge clip (3) further comprises at one end a detent (9) that projects inward for engaging with the recess.

The invention relates to a hinge connection between a cover and a transport container made of plastic according to the preamble of claim 1.

### STATE-OF-THE-ART

For increasing the mechanical strength of a hinge connection between a cover and a transport container, hinge clips made of metal are typically used which are clamped onto the hinge in a wide groove. The hinge clip is formed as a circular-cylindrical sleeve extending over a circle of an arc of approximately 270° and has a bore to additionally attach the clamp with a screw or a rivet on the hinged part of the cover. Such hinge with a hinge clip is described, for example, in Euro-Catalogue 1999 from the company Georg Utz AG, page 35. Several problems are encountered when using metallic hinge clips on a hinge part of the cover to thus form a hinge connection with the transport container made of plastic. The metallic hinge clips must be held in place during assembly and pushed onto the wide groove of the hinge part with a hammer. The hinge clips are made of spring steel and can only be removed again with a tool. When these transport containers are recycled, the hinge clips must be removed first, before the containers can be ground up in a mill.

### OBJECT OF THE INVENTION

It is the object of the present invention to provide a simple and recyclable hinge connection for a cover on a transport container which has a mechanical stability which is comparable to that of a hinge connection secured by a metallic hinge clip.

### SUBJECT MATTER OF THE INVENTION

The object is attained by a hinge connection having the features of claim 1.

The hinge connection according to the invention has the significant advantage of being particularly easy to assemble, very stable and facilitating a simple exchange of existing hinge connections of the aforedescribed type.

### DESCRIPTION OF AN EXEMPLARY EMBODIMENT OF THE INVENTION

Additional advantages of the invention are recited in the dependent claims and described in the following description, in which the invention is described in more detail with reference to an exemplary embodiment illustrated in the schematic drawings. It is shown in

FIG. 1 a side view on a hinge part and a hinge clip,

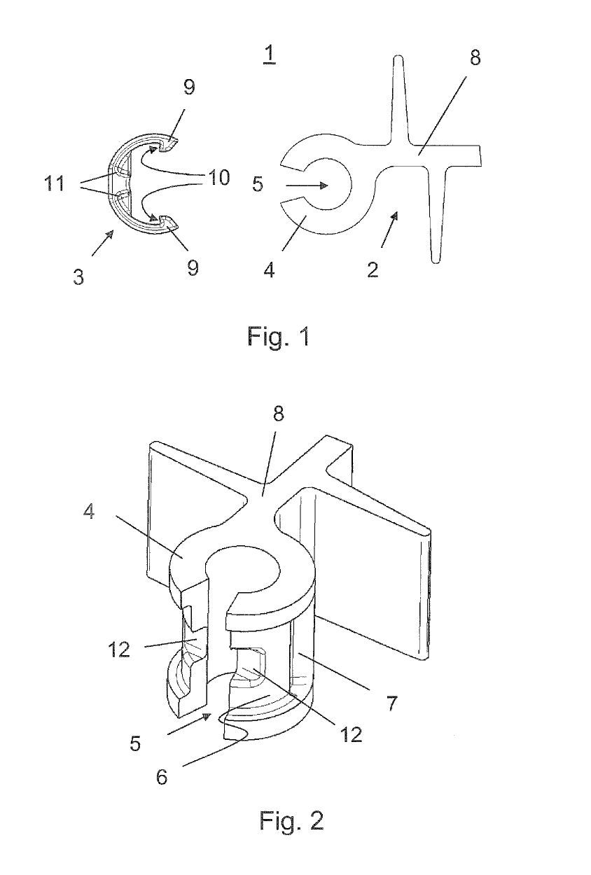

FIG. 2 a perspective view of the hinge part,

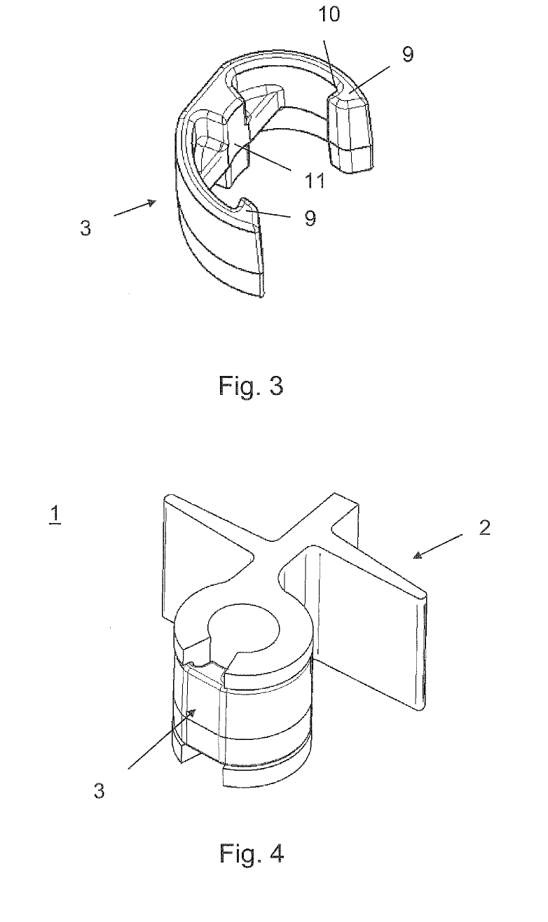

FIG. 3 a perspective view of the hinge clip, and

FIG. 4 a perspective view of the installed hinge connection.

FIGS. 1 to 4 illustrate a hinge connection 1 for a transport container made of plastic, wherein the hinge connection 1 has a hinge part 2 and a hinge clamp 3. The hinge part 3 is constructed as a sleeve 4 with a longitudinal opening 5, wherein the sleeve 4 has wide outer grooves 6 with a trough-shape recess 7 arranged on both sides of the longitudinal opening 5. The sleeve 4 is connected with an angular connecting piece 8 which is part of the cover of the transport container (not illustrated in detail). The hinge clip 3 has the same width as the wide outer groove 6 of the hinge part 2 and has a rod-shaped detent 9 with a locking edge 10. As seen in the Figures, the hinge clip 3 is formed as a circular cylinder with a circular arc of approximately to 220°. This circular arc should be greater than 180° and smaller than 270°, and should be particularly in a range from 200° to 240° so as to ensure adequate clamping of the hinge clip 3 on the hinge part 2. The hinge clip 3 also includes a bridge-shape reinforcement 11 arranged centrally to the two ends or detents 9 so as to fit into the longitudinal opening 5. For this purpose, additional trough-shaped recesses 12 are provided on the free ends of the sleeve 4 in which the bridge-shaped reinforcement 11 can be clamped. The bridge-shaped reinforcement 11 thus provides high stability to the hinged clip 3 and excellent spring elasticity at the ends of the detents 9.

The hinge connection 1 is produced from the same plastic material (polyethylene or polypropylene) as the transport container, so that the entire plastic container can be easily recycled.

The hinge part 2 does not necessarily require a hinge clip 3 because it is clamped on the container on a pivot pin. The hinge clip 3 is used only to additionally secure the cover. Advantageously, the hinge clip 3 and therefore also the cover on which the hinge part 3 is formed can be easily removed without use of a tool.

A person skilled in the art will understand that two rod-shaped detents may be provided instead of a single rod-shaped detent 9. It is also not necessary to provide detents on both sides of the hinge clip 3; instead, a single detent 9 and a single recess in the hinge part 2 may be sufficient.

What is claimed is:

1.-7. (canceled)

8. A hinge connection for a transport container made of plastic, comprising:
a hinge part constructed as a sleeve and having a longitudinal opening and a wide circumferential outer groove having free ends, with a recess disposed on at least on one of the free ends of the circumferential outer groove, and
a hinge clip encompassing the sleeve and having two ends, said hinge clip received in the circumferential outer groove and having an inwardly projecting detent configured to lock in the recess,
wherein the hinge clip comprises a bridge-shaped reinforcement arranged at a center located between the two ends of the hinge clip and constructed to fit in the longitudinal opening of the hinge part.

9. The hinge connection of claim 8, wherein the circumferential outer groove has two free ends, with a corresponding recess disposed on each of the two free ends, and wherein the hinge clip has a corresponding inwardly projecting detent disposed on each of the two ends of the hinge clip.

10. The hinge connection of claim 8, wherein the recess is formed as a trough.

11. The hinge connection of claim 8, wherein the detent is constructed as a rod having a locking edge.

12. The hinge connection of claim 8, wherein the hinge clip is formed as a circular cylinder with a circular arc having an angle greater than 180° and smaller than 270°.

13. The hinge connection of claim 8, wherein the hinge clip is formed as a circular cylinder with a circular arc having an angle between 200° and 240°.

14. The hinge connection of claim 8, wherein the hinge clip is made of plastic.

15. The hinge connection of claim 8, wherein the free ends of the hinge part comprise additional trough-shaped recesses, with the additional trough-shaped recesses configured to receive the bridge-shaped reinforcement of the hinge clip.
